(19) United States
(12) Patent Application Publication
(10) Pub. No.: US 2025/0372764 A1
(43) Pub. Date: Dec. 4, 2025

(54) Outlet Duct System for Vehicle Air-Cooled Battery

(71) Applicants: Hyundai Motor Company, Seoul (KR); Kia Corporation, Seoul (KR)

(72) Inventor: Seon Ung Youn, Hwaseong-Si (KR)

(21) Appl. No.: 18/937,701

(22) Filed: Nov. 5, 2024

(30) Foreign Application Priority Data
Jun. 4, 2024 (KR) 10-2024-0073290

(51) Int. Cl. H01M 10/6566; B60N 3/04; B60R 13/08; B60R 16/04; H01M 10/613; H01M 10/625; H01M 50/249; H01M 50/30; H01M 50/358

(52) U.S. Cl. CPC H01M 10/6566; B60N 3/042; B60R 13/0846; B60R 16/04; H01M 10/613; H01M 10/625; H01M 50/249; H01M 50/358; H01M 50/394; H01M 2220/20

(57) ABSTRACT

An outlet duct system for a vehicle air-cooled battery includes: a first duct fluidly connected to a battery assembly disposed under a floor of a vehicle, and mounted on a top surface of the floor; and a second duct communicating with the first duct, and having an outlet opening through which air is discharged to the floor, wherein the second duct includes a plurality of holes provided in a portion thereof adjacent to the outlet opening, and each hole has a diameter less than an opening area of the outlet opening.

### CROSS-REFERENCE TO RELATED APPLICATION

This application is based on and claims the benefit of priority to Korean Patent Application No. 10-2024-0073290, filed on Jun. 4, 2024, in the Korean Intellectual Property Office, the disclosure of which is incorporated herein in its entirety by reference.

### TECHNICAL FIELD

The present disclosure relates to an outlet duct system for a vehicle air-cooled battery, and more particularly, to an outlet duct system, for a vehicle air-cooled battery, designed to allow air, flowing out from a vehicle battery assembly, to be discharged.

### BACKGROUND

An electric vehicle or hybrid vehicle may include a battery (e.g., disposed under a floor). The electric vehicle or hybrid vehicle may further include a battery cooling system for maintaining the battery at an appropriate temperature.

The performance of high-voltage components, including the battery, may vary depending on temperature, so it is important to maintain the high-voltage components at appropriate temperatures (e.g., for sufficient performance). The battery of the vehicle may be part of an air-cooled battery system, which is cooled by air, or part of a liquid-cooled battery system, which is cooled by liquid.

The air-cooled battery system may be configured to cool the battery using indoor air of the vehicle. A battery assembly may be disposed in the vehicle, such as under the floor. The battery assembly may include a battery case and a plurality of battery cells disposed inside the battery case. An air intake grille may be provided (e.g., in the floor and/or in another compartment comprising the battery assembly), and the air may be sucked from the interior of the vehicle into an interior space of the battery case through the air intake grille by the operation of a cooling fan. As the sucked air passes through the interior space of the battery case, the plurality of battery cells may exchange heat with the air. The plurality of battery cells may be cooled to an appropriate temperature by the air, the air may be heated by the plurality of battery cells, and the heated air may flow out from the battery case. The air flowing out from the battery case may be discharged into the interior of the vehicle through an outlet duct. To prevent moisture and/or foreign objects from entering the outlet duct, the outlet duct may be mounted on a top surface of the floor in a longitudinal direction of the vehicle.

In the air-cooled battery system, noise may be generated for the following reasons: noise caused by the cooling fan, noise generated at an outlet opening of the outlet duct, and/or noise caused due to friction between the air and the outlet duct. In particular, when the air flowing out from the battery assembly is discharged to the floor of the vehicle through the outlet opening of the outlet duct, a relatively drastic change in pressure and air speed at the outlet opening of the outlet duct may cause the generation of noise at the outlet opening of the outlet duct. In addition, as the temperature of the battery increases, rotations per minute (RPM) of the cooling fan may increase. Accordingly, as an air flow rate increases, noise caused by friction between the air and peripheral components may increase. As the RPM of the cooling fan increases, vibration of the outlet duct caused by the air flow may be increasingly delivered to passengers, which reduces passenger comfort.

The above information described in this background section is provided to assist in understanding the background of the inventive concept, and may include any technical concept which is not considered as the prior art that is already known to those skilled in the art.

### SUMMARY

The following summary presents a simplified summary of certain features. The summary is not an extensive overview and is not intended to identify key or critical elements.

Systems, apparatuses, and methods are described for an outlet duct system for a vehicle air-cooled battery. An outlet duct system for a vehicle air-cooled battery may comprise a first duct fluidly connected to a battery assembly disposed under a floor of a vehicle, wherein the first duct is mounted on a top surface of the floor; and a second duct configured to receive air from the first duct, wherein the second duct comprises an outlet opening configured to discharge air to the floor. The second duct comprises a surface, in which a plurality of holes are formed, adjacent to the outlet opening, and each hole has an opening area less than an opening area of the outlet opening.

Also, or alternatively, an outlet duct system for a vehicle air-cooled battery comprises a first duct configured to, when mounted on a top surface of a floor of a vehicle, provide air to a battery assembly disposed under the floor of the vehicle; and a second duct, configured to receive air from the first duct, comprising: an outlet forming an opening configured to discharge the air, and one or more walls, adjacent to the opening of the outlet, forming a plurality of holes each having an opening area less than an opening area of the opening of the outlet.

Also, or alternatively, a vehicle may comprise a battery assembly disposed under a floor of the vehicle; and an outlet duct system mounted on a top surface of the floor. The outlet duct system may comprise a first duct fluidly connected to the battery assembly; and a second duct configured to receive air from the first duct, wherein the second duct comprises an outlet opening configured to discharge the air to the floor. The second duct may comprise a surface, in which a plurality of holes are formed, adjacent to the outlet opening, and each hole may have an opening area less than an opening area of the outlet opening.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings.

FIG. 1 illustrates a plan view of an outlet duct system for a vehicle air-cooled battery according to an example of the present disclosure;

FIG. 2 illustrates a side view of an outlet duct system for a vehicle air-cooled battery according to an example of the present disclosure;

FIG. 3 illustrates an enlarged view of a second duct of an outlet duct system for a vehicle air-cooled battery according to an example of the present disclosure;

FIG. 4 illustrates a cross-sectional view, taken along line A-A of FIG. 3;

FIG. 5 illustrates a cross-sectional view, taken along line B-B of FIG. 3;

FIG. 6 illustrates an enlarged view of a rear portion of a second duct of an outlet duct system for a vehicle air-cooled battery according to an example of the present disclosure;

FIG. 7 illustrates an enlarged view of a rear portion of a second duct of an outlet duct system for a vehicle air-cooled battery according to another example of the present disclosure; and

FIG. 8 illustrates an enlarged view of a rear portion of a second duct of an outlet duct system for a vehicle air-cooled battery according to another example of the present disclosure.

### DETAILED DESCRIPTION

Hereinafter, examples of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

Terms such as first, second, A, B, (a), and (b) may be used to describe the elements in examples of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

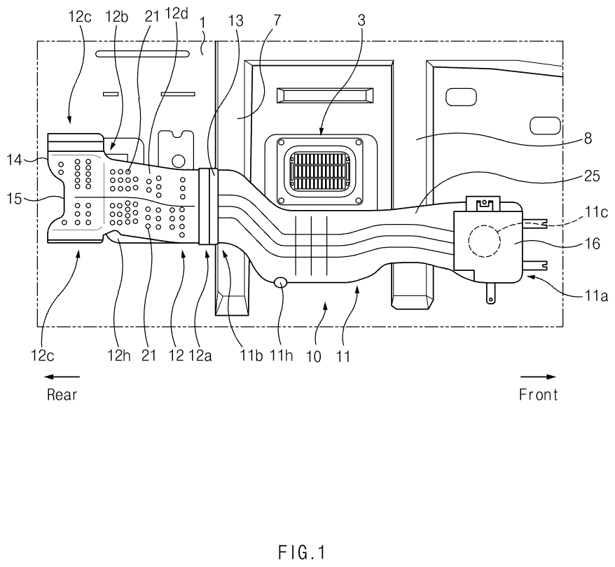

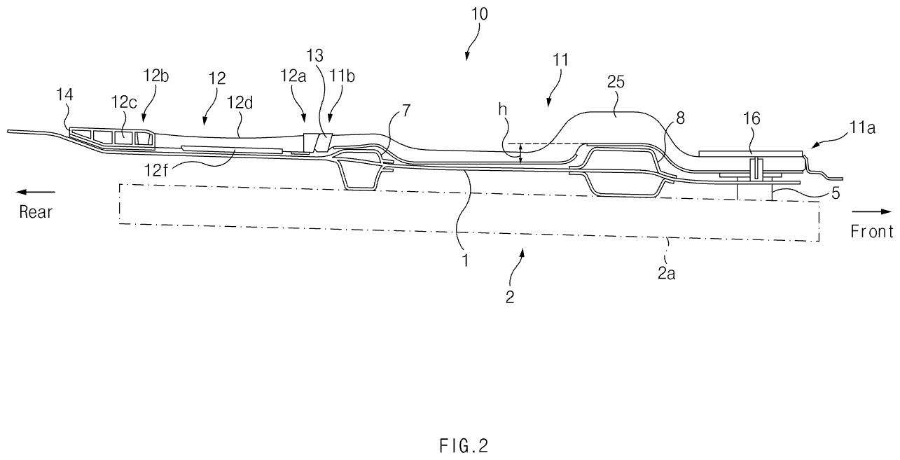

Referring to FIGS. 1 and 2, an outlet duct system 10 for a vehicle air-cooled battery according to an example of the present disclosure may be mounted on a top surface of a floor 1 of a vehicle). Please note, the outlet duct system 10 may be mounted in another internal surface of the vehicle (e.g., on an internal surface of a wall, ceiling, door, etc.), but the example of the outlet duct system 10 being mounted in/on the floor 1 will be discussed herein for clarity/simplicity. The outlet duct system 10 for a vehicle air-cooled battery may include one or more ducts 11 and 12 extending in a direction (e.g., a reference direction, a longitudinal direction) of the vehicle.

Referring to FIG. 1, an air intake grille 3 may be provided in the floor 1. Referring to FIG. 2, a battery case 2a of a battery assembly 2 may be disposed under the floor 1. A plurality of battery cells may be disposed in an interior space of the battery case 2a.

The air intake grille 3 may fluidly communicate with (e.g., may allow for airflow into) an inlet of the battery case 2a, and indoor air may flow into and/or be sucked into (e.g., by operation of a cooling fan—not shown) the interior space of the battery case 2a through the air intake grille 3. The air flowing/sucked into the interior space of the battery case 2a may exchange heat with the plurality of battery cells so that the plurality of battery cells may be cooled, and the air may absorb heat from the plurality of battery cells so that the air may be heated. The heated air may flow out from the battery case 2a, and the air flowing out from the battery case 2a may be discharged and/or guided to the floor 1 of the vehicle through the outlet duct system 10 for a vehicle air-cooled battery.

The outlet duct system 10 for the vehicle air-cooled battery may include one or more ducts 11 and 12 for guiding the air flowing from the battery case 2a along the direction (e.g., the reference direction, the longitudinal direction) of the vehicle.

Referring to FIGS. 1 and 2, the outlet duct system 10 for a vehicle air-cooled battery may include a first duct 11 extending from the front of the vehicle toward the rear of the vehicle, and a second duct 12 extending from the first duct 11 toward the rear of the vehicle.

The first duct 11 may include a front portion 11a facing the front of the vehicle, and a rear portion 11b facing the rear of the vehicle. The first duct 11 may extend in the longitudinal direction of the vehicle. The first duct 11 may be fluidly connected to the battery assembly 2 (e.g., the first duct 11 may be connected to the battery assembly 2 such that air can flow between the first duct 11 and the battery assembly 2). Referring to FIG. 1, the front portion 11a of the first duct 11 may have a front opening 11c communicating with an outlet of the battery case 2a of the battery assembly 2. The front opening 11c of the first duct 11 may communicate (e.g., via air flow) with the outlet of the battery case 2a through a pipe 5. The air flowing out from the outlet of the battery case 2a may be directed into the front opening 11c of the first duct 11 through the pipe 5. The air flowing into the front opening 11c may flow along a longitudinal direction of the first duct 11 in an interior space of the first duct 11. The first duct 11 may have at least one mounting lug 11h, and the first duct 11 may be fixed to the top surface of the floor 1 through the at least one mounting lug 11h.

If the air flowing out from the outlet of the battery case 2a is directed into the front opening 11c of the first duct 11 (e.g., through the pipe 5), the air flowing into the front opening 11c may hit the front portion 11a of the first duct 11, thereby generating noise. Referring to FIGS. 1 and 2, a noise absorbing material 16 may be mounted on the front portion 11a of the first duct 11, and the noise absorbing material 16 may be configured absorb noise due to air flowing into the front opening 11c of the first duct 11, so that the generation of noise may be reduced and/or minimized.

Referring to FIGS. 1 and 2, the second duct 12 may include a front portion 12a facing the front of the vehicle, and a rear portion 12b facing the rear of the vehicle. The front portion 12a of the second duct 12 may be connected to the rear portion 11b of the first duct 11 so that they may communicate with each other (e.g., air may flow therebetween). The second duct 12 may have at least one mounting lug 12h, and the second duct 12 may be fixed to the top surface of the floor 1 through the at least one mounting lug 12h.

A pair of seat rails 18 and 19 may be disposed on both sides of the second duct 12. Seat mounts of a vehicle seat may be mounted on the pair of seat rails 18 and 19, respectively. The second duct 12 may have a pair of outlet openings 12c provided on both left and right sides of the rear portion 12b, respectively. The outlet openings 12c may be adjacent to the corresponding seat rails 18 and 19. The air flowing into the second duct 12 from the first duct 11 may flow along a longitudinal direction of the second duct 12 in an interior space of the second duct 12, and the air may be discharged through the pair of outlet openings 12c.

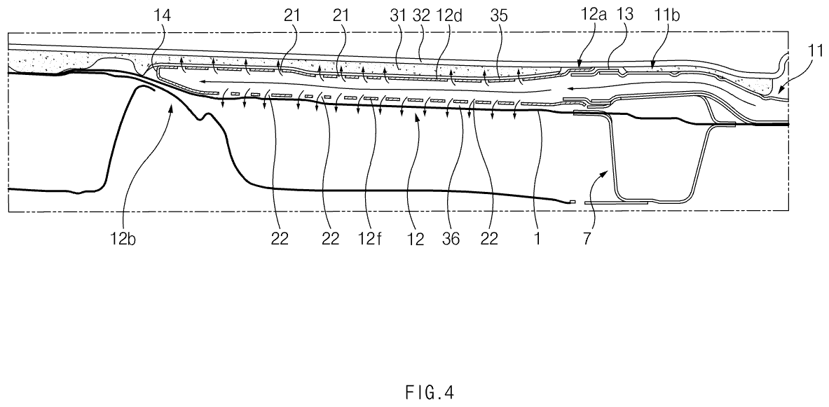

Referring to FIG. 4, the outlet duct system 10 for a vehicle air-cooled battery according to an example of the present disclosure may include a carpet pad 31 covering: the top surface of the floor 1, a top surface of the first duct 11, and a top surface of the second duct 12. A carpet skin 32 may be stacked on at least a part of a top surface of the carpet pad 31. The first duct 11 and the second duct 12 may be disposed on the top surface of the floor 1, and the carpet pad 31 may cover the entirety of the top surface of the floor 1 while covering the ducts 11 and 12 and peripheral regions of the ducts 11 and 12. Accordingly, the first duct 11 and the second duct 12 may be covered with the carpet pad 31 and the carpet skin 32 above the floor 1, and the air discharged from the outlet openings 12c of the second duct 12 may be blocked, by the carpet pad 31 and the carpet skin 32, from being delivered to passengers. That is, the air from the battery case 2a of the battery assembly 2 and discharged to the floor 1 of the vehicle through the outlet openings 12c of the outlet duct system 10 may be blocked from being delivered to the passengers in the passenger compartment.

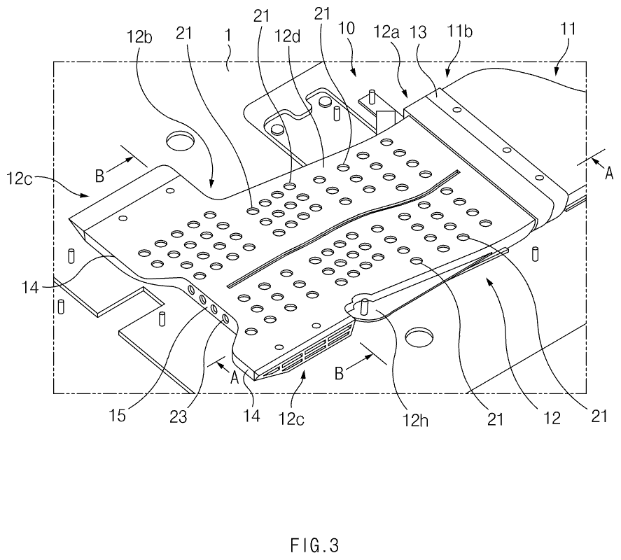

Referring to FIGS. 3 and 4, the second duct 12 may have a plurality of holes 21 and 22 provided in a portion thereof adjacent to the outlet opening 12c, and at least a portion of the air may be discharged through the plurality of holes 21 and 22 before being discharged through the outlet openings 12c.

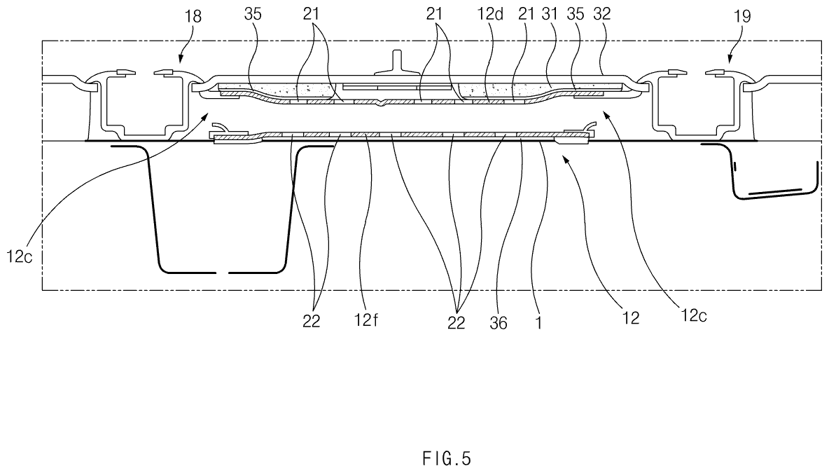

Referring to FIGS. 4 and 5, the second duct 12 may have a top wall 12d facing the top thereof. The top wall 12d of the second duct 12 may be spaced apart from the carpet pad 31 by a small gap as an upper gap 35 formed between the carpet pad 31 and the top wall 12d of the second duct 12. The second duct 12 may have a plurality of upper holes 21 formed in the top wall 12d. The plurality of upper holes 21 so formed in the top wall 12d may therefore open towards and/or face the carpet pad 31 relative to an internal space of the second duct 12. Each upper hole 21 may have a diameter less than an opening area of the outlet opening 12c. For example, the diameter of the upper hole 21 may be 12 mm, and when the diameter of the upper hole 21 is less than or equal to 12 mm, whistle noise may be generated or blockage of foreign objects may occur. The plurality of upper holes 21 may be uniformly disposed in the top wall 12d of the second duct 12. A portion of the air flowing along the longitudinal direction of the second duct 12 in the interior space of the second duct 12 may flow into the upper gap 35 between the carpet pad 31 and the top wall 12d through the plurality of upper holes 21. The plurality of upper holes 21 may move a noise frequency range (e.g., towards a frequency range outside of perceivable frequency range). The plurality of upper holes 21 moving the noise frequency range may therefore reduce noise perceivable by the passenger. A flow direction of the air passing through the plurality of upper holes 21 may be perpendicular to the longitudinal direction of the second duct 12.

Referring to FIGS. 4 and 5, the second duct 12 may have a bottom wall 12f facing the top wall 12d. The bottom wall 12f of the second duct 12 may be spaced apart from the floor 1 by a small gap forming a lower gap 36 between the floor 1 and the bottom wall 12f of the second duct 12. The second duct 12 may have a plurality of lower holes 22 formed in the bottom wall 12f. The plurality of lower holes 22 so formed in the bottom wall 12f may therefore open towards and/or face the floor 1. One or more of (e.g., each) of the lower holes 22 may have an opening area less than an opening area of the outlet opening 12c. For example, the diameter of each of the lower holes 22 may be about 12 mm or greater. If the diameter of the lower hole 22 is less than or equal to about 12 mm, whistle noise may be generated or blockage of the lower holes 22 by foreign objects may occur. The plurality of lower holes 22 may be uniformly disposed (e.g., distributed) in the bottom wall 12f of the second duct 12. A portion of the air flowing along the longitudinal direction of the second duct 12 in the interior space of the second duct 12 may flow into the lower gap 36 between the bottom wall 12f and the floor 1 through the plurality of lower holes 22. As the plurality of lower holes 22 are formed in the bottom wall 12f of the second duct 12, moisture (e.g., flowing in through the plurality of upper holes 21, forming in the in second duct 12) may be discharged through the plurality of lower holes 22. The plurality of lower holes 22 may move a noise frequency range (e.g., towards a frequency range outside of perceivable frequency range). The plurality of lower holes 22 moving the noise frequency range may therefore reduce noise perceivable by the passenger. A flow direction of the air passing through the plurality of lower holes 22 may be (e.g., substantially) perpendicular to the longitudinal direction of the second duct 12.

As described herein, at least a portion of the air may be discharged through the plurality of upper holes 21 and the plurality of lower holes 22 before a remainder of the air is discharged through the outlet openings 12c. As such, pressure and air speed at the outlet openings 12c of the second duct 12 may be changed/decreased, and pressure in the interior space of the second duct 12 may be relatively lowered. Accordingly, the generation of noise and/or vibration at the outlet openings 12c of the second duct 12 may be minimized. In addition, as the air is discharged through the outlet openings 12c, the plurality of upper holes 21, and the plurality of lower holes 22, the total flow rate of the air discharged from the second duct 12 may relatively increase so that the flow rate of the air flowing into the battery case 2a of the battery assembly 2 may increase. Accordingly, the cooling of the plurality of battery cells (battery cooling performance) may be improved.

The second duct 12 may include a rear end wall 14 provided on the rear portion 12b and a recessed wall 15 recessed from the rear end wall 14 toward the front portion 12a. A flat surface of the rear end wall 14 and a flat surface of the recessed wall 15 may be perpendicular to a longitudinal axis of the second duct 12.

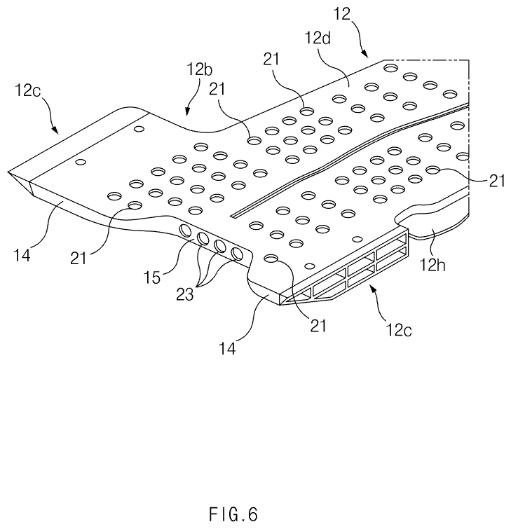

Referring to FIG. 6, the second duct 12 may have a plurality of rear holes 23 provided in the recessed wall 15.

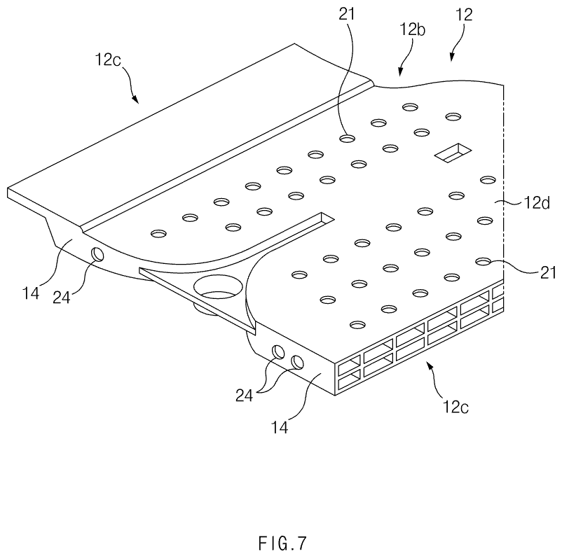

Referring to FIG. 7, the second duct 12 may have a plurality of rear holes 24 provided in the rear end wall 14. FIG. 7 illustrates two right rear holes 24 and one left rear hole 24 provided in the rear end wall 14.

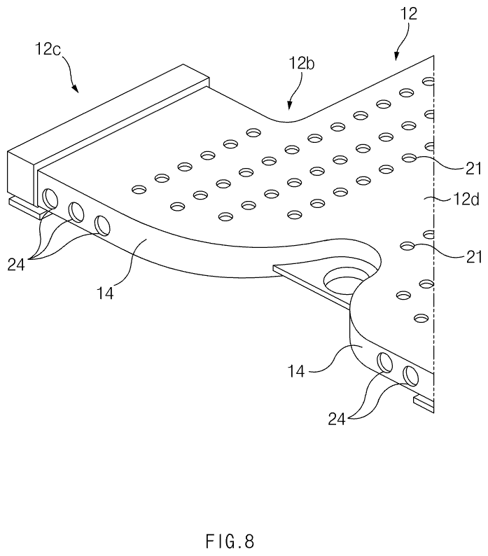

Referring to FIG. 8, the second duct 12 may have a plurality of rear holes 24 provided in the rear end wall 14. FIG. 8 illustrates two right rear holes 24 and three left rear holes 24 provided in the rear end wall 14.

Referring to FIGS. 6 to 8, at least a portion of the air flowing along the longitudinal direction of the second duct 12 in the interior space of the second duct 12 may be directed toward the rear of the vehicle through the plurality of rear holes 23 and 24. Since the flow direction of the air passing through the plurality of rear holes 23 and 24 is (e.g., substantially) parallel to the longitudinal direction of the second duct 12, straightness of the air flow may be secured. Accordingly, the flow rate of the air passing through the plurality of rear holes 23 and 24 may increase.

According to an example, the front portion 12a of the second duct 12 may be integrally connected to the rear portion 11b of the first duct 11 so that the first duct 11 and the second duct 12 may form a unitary one-piece structure. According to another example, the first duct 11 and the second duct 12 may be manufactured individually, and the front portion 12a of the second duct 12 and the rear portion 11b of the first duct 11 may be connected through a connector 13. As the first duct 11 and the second duct 12 are manufactured individually, the manufacturing of the first duct 11 and the second duct 12 may be easily performed.

Referring to FIGS. 1 and 2, crossmembers 7 and 8 may extend in a width direction of the floor 1, and the first duct 11 may be supported by/attached to the crossmembers 7 and 8. The rear portion 11b of the first duct 11 may be bent, for example, so as to fit to and/or be supported by the crossmember 7.

Referring to FIG. 2, the outlet duct system 10 for a vehicle air-cooled battery according to an example of the present disclosure may further include a ridge portion 25 raised upward from a portion of the first duct 11 adjacent to the front portion 11a of the first duct 11. The ridge portion 25 may be seated on the crossmember 8. A bottom surface of the ridge portion 25 may be higher than a bottom surface of the first duct 11 by a predetermined height h. Accordingly, when moisture and the like flows in through the upper holes 21 and/or the lower holes 22 of the second duct 12, the ridge portion 25 may prevent moisture from flowing into the front opening 11c of the first duct 11.

The present disclosure has been made to solve the above-mentioned problems occurring in the prior art while advantages achieved by the prior art are maintained intact.

An aspect of the present disclosure provides an outlet duct system for a vehicle air-cooled battery designed to minimize the generation of noise and/or vibration when air flowing out from a vehicle battery assembly is discharged to a floor of a passenger compartment of a vehicle.

According to an aspect of the present disclosure, an outlet duct system for a vehicle air-cooled battery may include: a first duct fluidly connected to a battery assembly disposed under a floor of a vehicle, and mounted on a top surface of the floor; and a second duct communicating with the first duct, and having an outlet opening through which air is discharged to the floor. The second duct may include a plurality of holes provided in a portion thereof adjacent to the outlet opening, and each hole may have a diameter less than an opening area of the outlet opening.

The plurality of holes may include a plurality of upper holes provided in a top wall of the second duct.

The plurality of holes may further include a plurality of lower holes provided in a bottom wall of the second duct.

The plurality of holes may further include a plurality of rear holes provided in a rear portion of the second duct.

The outlet duct system may further include a carpet pad covering the top surface of the floor, a top surface of the first duct, and a top surface of the second duct.

The top wall of the second duct may be spaced apart from the carpet pad by a predetermined gap, and the plurality of upper holes may face the carpet pad.

The bottom wall of the second duct may be spaced apart from the floor by a predetermined gap, and the plurality of lower holes may face the floor.

The first duct and the second duct may extend in a longitudinal direction of the vehicle, the first duct may extend from the front of the vehicle toward the rear of the vehicle, and the second duct may extend from the first duct toward the rear of the vehicle.

The first duct may include a front portion facing the front of the vehicle, and a rear portion facing the rear of the vehicle. The front portion of the first duct may have a front opening communicating with the battery assembly.

The outlet duct system may further include a noise absorbing material attached to the front portion of the first duct.

The outlet duct system may further include a ridge portion raised upward from a portion of the first duct adjacent to the front portion of the first duct. A bottom surface of the ridge portion may be higher than a bottom surface of the first duct by a predetermined height.

As set forth above, the outlet duct system for a vehicle air-cooled battery according to examples of the present disclosure may be designed to change (e.g., moderately) the pressure and air speed at the outlet opening of the duct by providing the plurality of holes in a portion of the duct adjacent to the outlet opening through which the air flowing out from the vehicle battery assembly is discharged to the floor of the vehicle, thereby minimizing the generation of noise and/or vibration at the outlet opening.

Although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An outlet duct system for a vehicle air-cooled battery, the outlet duct system comprising:
a first duct fluidly connected to a battery assembly disposed under a floor of a vehicle, wherein the first duct is mounted on a top surface of the floor; and
a second duct configured to receive air from the first duct, wherein the second duct comprises an outlet opening configured to discharge air to the floor,
wherein the second duct comprises a surface, in which a plurality of holes are formed, adjacent to the outlet opening, and
wherein each hole has an opening area less than an opening area of the outlet opening.

2. The outlet duct system according to claim 1, wherein the plurality of holes comprise a plurality of upper holes provided in a first wall, of the second duct, facing away from the floor.

3. The outlet duct system according to claim 2, wherein the plurality of holes further comprise a plurality of lower holes provided in a second wall, of the second duct, facing toward the floor.

4. The outlet duct system according to claim 3, wherein the plurality of holes further comprise a plurality of rear holes provided in a portion of the second duct towards a rear of the vehicle.

5. The outlet duct system according to claim 3, further comprising a carpet pad covering:
at least a portion of the top surface of the floor,
a top surface of the first duct, and
a top surface of the second duct.

6. The outlet duct system according to claim 5, wherein:
the first wall of the second duct is spaced apart from the carpet pad by a predetermined gap, and
the plurality of upper holes face the carpet pad.

7. The outlet duct system according to claim 5, wherein:
the second wall of the second duct is spaced apart from the floor by a predetermined gap, and
the plurality of lower holes face the floor.

8. The outlet duct system according to claim 1, wherein the first duct and the second duct extend in a longitudinal direction of the vehicle,
the first duct extends in a direction from a front of the vehicle toward a rear of the vehicle, and
the second duct extends from the first duct toward the rear of the vehicle.

9. The outlet duct system according to claim 1, wherein:
the first duct comprises a front portion towards a front of the vehicle, and a rear portion towards a rear of the vehicle, and
the front portion of the first duct forms an opening configured to communicate via air flow with the battery assembly.

10. The outlet duct system according to claim 9, further comprising a noise absorbing material attached to the front portion of the first duct.

11. The outlet duct system according to claim 9, further comprising a ridge portion raised away from the floor relative to a portion of the first duct adjacent to the front portion of the first duct,
wherein a bottom surface of the ridge portion is higher than another bottom surface of the first duct.

12. An outlet duct system for a vehicle air-cooled battery, the outlet duct system comprising:
a first duct configured to, when mounted on a top surface of a floor of a vehicle, provide air to a battery assembly disposed under the floor of the vehicle; and
a second duct, configured to receive air from the first duct, comprising:
an outlet forming an opening configured to discharge the air, and
one or more walls, adjacent to the opening of the outlet, forming a plurality of holes each having an opening area less than an opening area of the opening of the outlet.

13. The outlet duct system according to claim 12, wherein the one or more walls comprise a first wall configured to face away from the floor and a second wall configured to face towards the floor, and wherein each of the first wall and the second wall form at least a portion of the plurality of holes.

14. The outlet duct system according to claim 13, wherein the one or more walls further comprise a rear wall configured to face a rear of the vehicle when the outlet duct system is installed in the vehicle, and wherein the rear wall further forms another portion of the plurality of holes.

15. The outlet duct system according to claim 13, further comprising a carpet pad configured to cover:
at least a portion of the top surface of the floor,
a top surface of the first duct, and
a top surface of the second duct.

16. The outlet duct system according to claim 15, wherein:
the first wall of the second duct is configured to be spaced apart from the carpet pad by a first gap when the outlet duct system is installed in the vehicle, and
the second wall of the second duct is configured to be spaced apart from the floor by a second gap when the outlet duct system is installed in the vehicle.

17. The outlet duct system according to claim 12, wherein the first duct and the second duct are configured to extend in a longitudinal direction of the vehicle, when the outlet duct system is installed in the vehicle, such that the second duct extends from the first duct toward a rear of the vehicle.

18. The outlet duct system according to claim 12, wherein:
the first duct comprises a front portion towards a front of the vehicle, and a rear portion towards a rear of the vehicle, and
the front portion of the first duct forms an opening configured to communicate via air flow with the battery assembly.

19. A vehicle comprising:
a battery assembly disposed under a floor of the vehicle; and
an outlet duct system mounted on a top surface of the floor, the outlet duct system comprising:
a first duct fluidly connected to the battery assembly; and
a second duct configured to receive air from the first duct, wherein the second duct comprises an outlet opening configured to discharge the air to the floor,
wherein the second duct comprises a surface, in which a plurality of holes are formed, adjacent to the outlet opening, and
wherein each hole has an opening area less than an opening area of the outlet opening.
